(19) United States
(12) Patent Application Publication
(10) Pub. No.: US 2007/0297615 A1
(43) Pub. Date: Dec. 27, 2007

(54) Computing Device with a Process-Based Keystore and method for Operating a Computing Device

(75) Inventors: Leun Clarke, London (GB); Craig Heath, Borchamwood (GB)

Correspondence Address: SYNNESTVEDT LECHNER & WOODBRIDGE LLP, P O BOX 592, 112 NASSAU STREET, PRINCETON, NJ, 08542-0592, US

(73) Assignee: Symbian Software Limited, London (UK)

(21) Appl. No.: 11/570,284

(22) PCT Filed: Jun. 8, 2005
(86) PCT No.: PCT/GB05/02241

§ 371 Date: Jun. 19, 2007

(30) Foreign Application Priority Data
Jun. 10, 2004 (GB) 0412919.3

(51) Int. Cl. H04L 9/00

(52) U.S. Cl. 380/286

(57) ABSTRACT

A computing device is provided with a key manager which provides a mechanism for distinguishing between authorised use and unauthorized use of a cryptographic key by identifying an owning application for each key, which is authorised by the key manager to freely use a particular key, and is also trusted to ask for explicit confirmation from the user when considered appropriate, such as when the key is used in a signing operation. To allow for sharing of keys between applications, the owning application may be enabled to designate a list of other applications which are also trusted to use the key.

The present invention relates to the secure management of cryptographic keys for computing devices, and in particular to the control of the use of encryption keys by requiring authentication (typically the entry of a PIN or passphrase) before permitting a key to be used for cryptographic operations (typically decryption or signing).

The term computing device as used herein is to be expansively construed to cover any form of electrical computing device and includes, data recording devices, computers of any type or form, including hand held and personal computers, and communication devices of any form factor, including mobile phones, smart phones, communicators which combine communications, image recording and/or playback, and computing functionality within a single device, and other forms of wireless and wired information devices.

Good key management is essential to all forms of security, whether electrical or mechanical. For example, the locks on a secure mechanical device may be of the highest standard but if the keys or combination for the locks are left in an insecure place, the lock standard itself becomes immaterial to maintain the security of the mechanical device.

It is well known that this principle also applies to computing devices, and that the integrity of the key manager is at least as important as the security of the keys themselves because it is generally recognized that most attacks on public-key security systems are most likely to be aimed at the key management level, rather than at the cryptographic algorithm itself.

Key managers exist on all devices which support cryptography; their purpose is to enable secure communications by facilitating the safe creation, import, export, maintenance and storage of one or both members of a key pair. They also play a critical role in PKI (Public Key Infrastructure) by providing safe storage and use of secure certificates and associated trust hierarchies.

Typically, key managers store keys in encrypted form in a secure location, generally known as a keystore, which relies on the authentication of clients seeking access to the keys it contains by means of passphrases and personal identification numbers (PINs) which are intended to safeguard the integrity of the cryptographic data contained in the keystore. In existing implementations of key managers, the authentication step actually performs two purposes. It allows the key manager software to determine that the authorised user of the software is actually present (as it is assumed that only the user knows the PIN or passphrase) and it also confirms that the user wishes the key to be used. For example, if rogue software attempts to invoke the key manager in order to sign a transaction which the user had not requested, then the appearance of the user interface requesting the user to authenticate himself/herself should alert the user that something was attempting to use his/her key, and the user would decline to authenticate.

The key manager in Microsoft Exchange works in this manner: http://www.msexchange.org/tutorials/Key_Management_Service_In_Exchange_{—}2000_Ser ver.html describes this type of key manager. There are also a number of Linux packages, such as keychain, offering similar facilities. Java's KeyStore class is a good example of how such a key manager application programming interface (API) has traditionally been implemented. The Java keystore class stores both keys and certificate. The API controlling access to the store associates passwords with cryptographic data by means of the methods setKeyEntry and store, and requires those same passwords when retrieving cryptographic data using methods such as getkey and load.

A concern with such general purpose key managers is their vulnerability to chosen protocol attacks. The meaning of a signing operation can be subverted to assert identity or to sign a particular piece of data depending on the protocol in use. An example of such an attack would be a malicious application purporting to do a secure sockets layer (SSL) handshake while in fact forging a signed S/MIME message.

The reason why such subversion is possible is because although the user knows how the key is supposed to be used from the context in which they are prompted to enter their passphrase or pin, the key manager does not know the purpose for which the passphrase or pin is being provided; the key manager is not provided with this information and has to assume that all requests for use are equally valid for all purposes. Responsibility for policing the use of the key is assigned to the application requesting key access, which is far from ideal if the application cannot be trusted.

This in turn means that with current designs not only can such attacks not be prevented, but also they cannot be detected, since the key manager is not able to inform the user about how a key is being used.

Consequently, a deficiency of the known implementations is that anyone who has sufficient access to the device and knowledge of the interface has the ability to compromise the integrity of the key store either by stealing, overwriting, deleting or withdrawing keys. Thus, in the absence of a proper security model for the whole platform, it is not possible to prevent malicious applications accessing whatever keys they want.

The perception behind this invention is that in a secure platform for a computing device the need to authenticate the user should be separated from the need to authorize the use of a key for a specific purpose.

For the purposes of this invention, a process is a set of one or more tasks executing on the device which occupies a single discrete memory area and which also has a unique persistent name. Thus, a process should be regarded as the unit of persistent executable identity on the device. The persistence of the identity of a process between instances of its execution is considered to be one of the key aspects of the present invention.

It is therefore an object of the present invention to provide an improved method for key management in a computing device.

According to a first aspect of the present invention there is provided a computing device arranged to provide secure use of data for cryptographic operations by
a. keeping each item of the said data in a keystore;
b. assigning ownership of items in the keystore to respective processes;
c. enabling respective processes to assign another process as a user of respective items;
d. enabling respective processes to delete or modify respective items; and
e. denying access to items in the keystore to processes that neither own an item nor have been assigned as a user of an item.

According to a second aspect of the present invention there is provided a method of operating a computing device for providing secure use of data for cryptographic operations, the method comprising
a. keeping each item of the said data in a keystore;
b. assigning ownership of items in the keystore to respective processes;
c. enabling respective processes to assign another process as a user of respective items;
d. enabling respective processes to delete or modify respective items; and
e. denying access to items in the keystore to processes that neither own an item nor have been assigned as a user of an item.

According to a third aspect of the present invention there is provided an operating system for a computing device for causing a computing device according to the first aspect to operate in accordance with a method of the second aspect

An embodiment of the present invention will now be described, by way of further example only, with reference to the accompanying drawings in which:

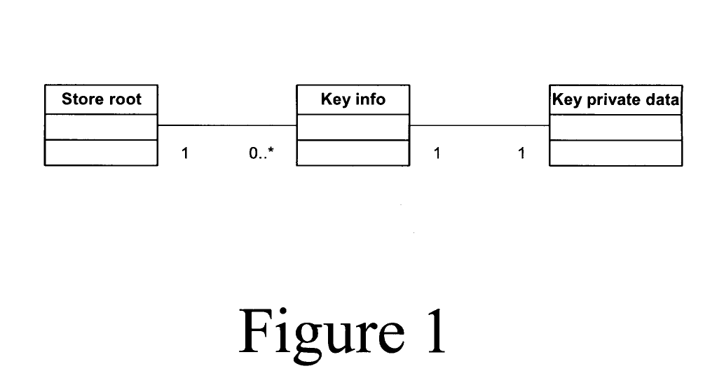

FIG. 1 shows an example of a root stream in a keystore;

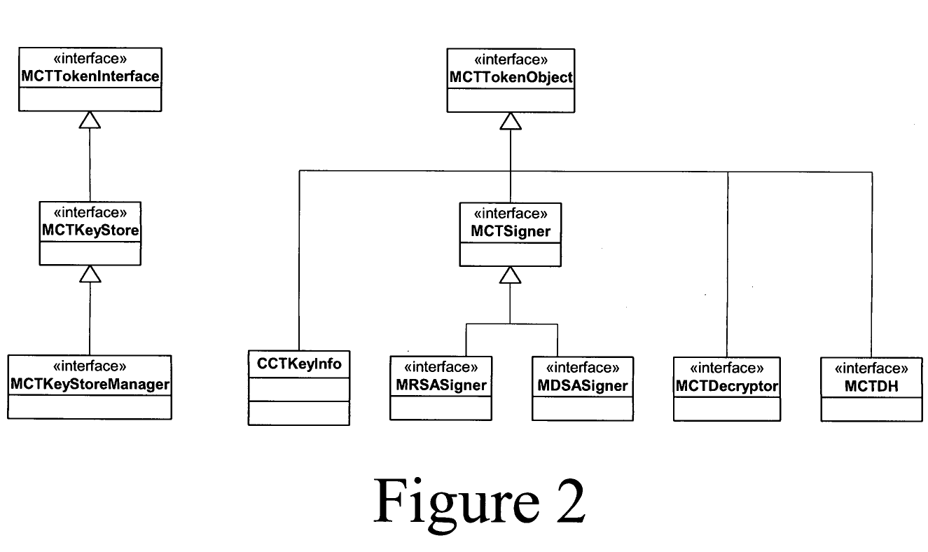

FIG. 2 shows an example of a keystore API;

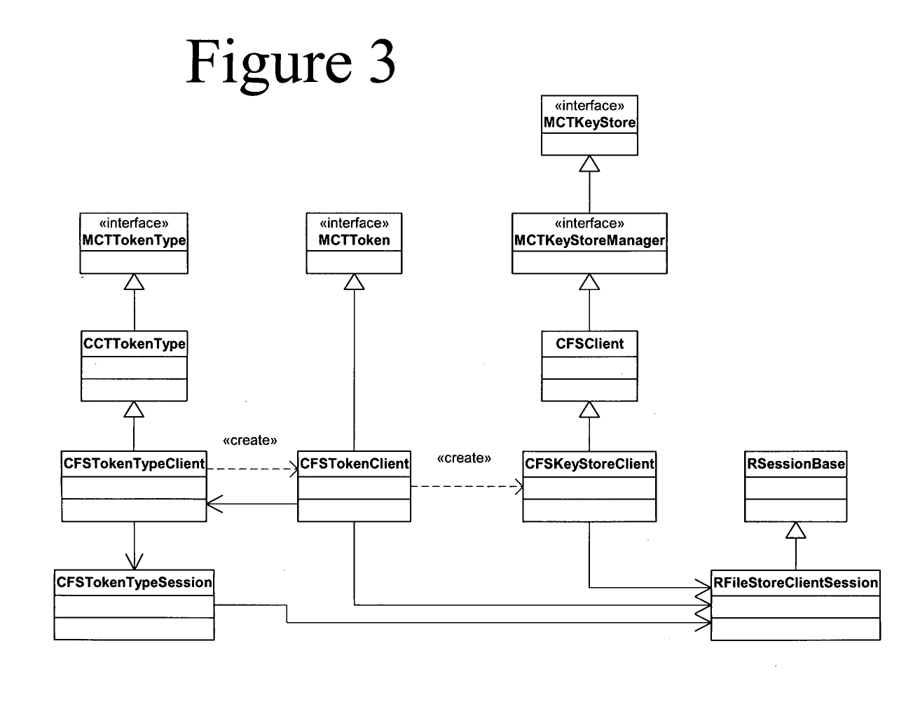

FIG. 3 shows an example of a keystore implementation of a cryptotoken framework API.

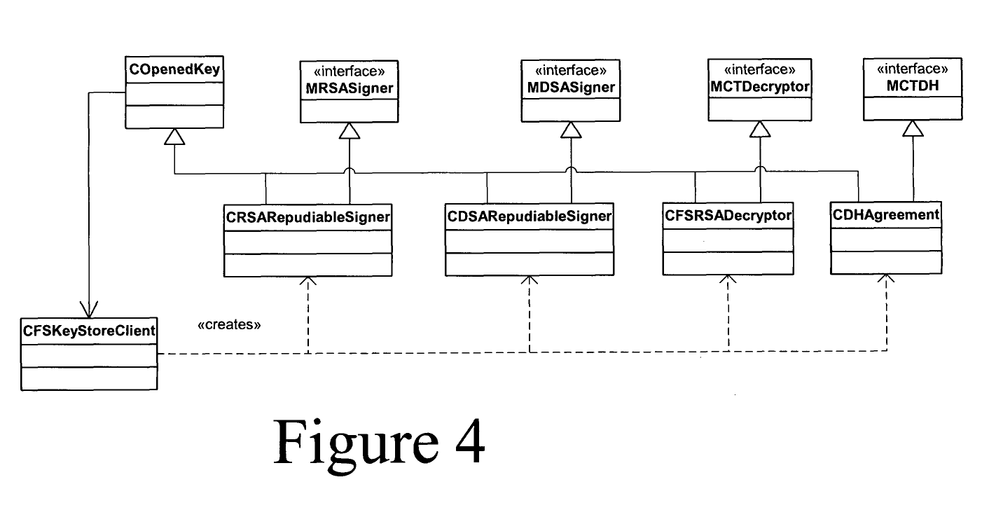

FIG. 4 shows an example of an implementation of a keystore API; and

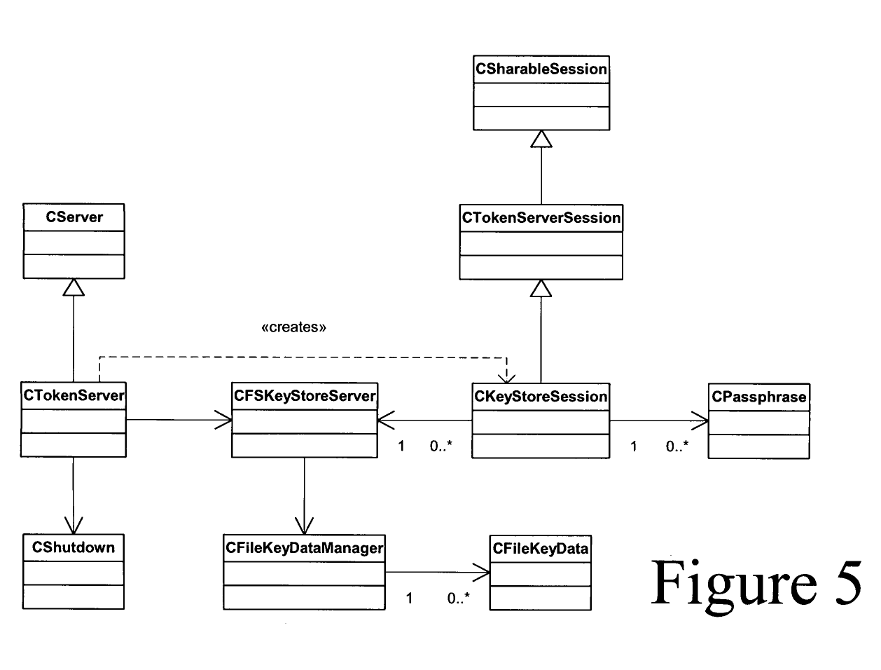

FIG. 5 shows an example of a structure for a keystore server.

The invention overcomes the concerns associated with the prior art as described above by limiting the scope of each key to specific applications. This is achieved by defining a process-based scheme of key owners and key users. Thus, a process ‘owns’ the keys that it has created or imported, and only the owning process is allowed to perform the full range of operations on those keys.

Some applications may either be implemented as several processes or may be closely coupled. Therefore, the ‘owner’ of a key is in such cases allowed to enable other applications to perform a fixed subset of operations on its keys. This is done by adding them as ‘users’ of individual keys. The subset of operations which user applications are allowed to perform is arranged to be sufficient to permit them to use the key for required cryptographic operations, but not to permit them to delete the key or to add other applications to the list of users of the key.

The present invention is underpinned by a dual API design for owners and users of the keystore APIs comprising
a user interface (UI) responsible for creating, deleting and managing keys
an ‘engine’ that actually uses the keys.

This dual API design corresponds to the distinction between key owners and key users.

An embodiment of a scheme for implementing this invention will now be described. This embodiment is described with reference to the Symbian OS™ operating system, the advanced operating system for mobile phones produced by Symbian Software Ltd of London.

One of the objects of this keystore design is to minimise the exposure of private keys to client applications. Therefore, it is implemented using a client/server architecture, with all private key operations carried out on the server side. However, those skilled in the art will readily be able to adapt the design for use in devices using other operating systems, and the following remarks which further outline the generic principles behind the invention are intended to aid the practitioner in such implementations.

In a preferred embodiment of the invention, the underlying operating system provides a secure way of ensuring that the unique identity of a process can be checked, since process identity determines the scope of the keystore APIs that it can handle. The Symbian OS™ operating system does this by means of unique identifiers (UIDs) attached to each process, coupled with a secure file structure. This procedure is described in UK patent application no. 0312190.2 entitled “Secure Mobile Wireless Device With Protected File System”. However, this invention is not restricted to this specific method, and any comparable method can be used. Alternative operating systems could have other means of identifying applications; for example based on digital signatures.

It should be noted that whatever process identity scheme is used, it will only be checked for uniqueness when an application is installed on the device, and when an application is uninstalled, its unique identifier should be removed from any authorization lists. Additionally, uninstallation of any application that owns keys is accompanied by the deletion of all keys that such an application owns. These steps can prevent a rogue application taking over any keys that have previously been used by an ‘uninstalled’ application.

However, this invention can also be implemented where a platform is unable to provide a secure mechanism for checking the identity of a process. The clear risk with such platforms is that of a malicious application attempting to assume the identity of another process and subvert the platform by using its keys. In such circumstances a different method may be used to prevent process identity being faked. Because the absence of secure process identification makes automatic verification impossible, more extensive use of manual verification methods needs to be used instead. Time-elapse passphrase handling schemes to authenticate processes for key use are quite suitable and one such implementation is discussed below. However, the frequent use of such a method is more intrusive and provides a less enchanting user experience than one able to rely merely on secure process identification.

While it is possible to list all keys on a device together with their owners, whether or not they are usable by the current application, applications seeking to list available keys on a device should use the feature enabling them to only list keys owned by a specific process that they trust. This avoids the risk of seeing and possibly using insecure keys that might have been added to the system by a malicious application.

This invention also works for Java implementations, such as J2ME, which use protocols such as the Secure Sockets Layer to secure network communications using key based cryptography. The Java virtual machine (JVM) knows what class of application it is running, and is therefore able to restrict its keys to ones owned by that application. Thus applets, which run inside a web browser, would be able to use the same keys as the browser process, while a different set of keys would be used for MIDlets.

This invention also allows alternative ways of mappings of keys to processes. For instance, security is essential for transactions that are conducted on computing devices in the form of mobile phones. One of the standards for these devices specifies the use of a hardware WIM (Wireless Identity Module) for securing sessions and storing keys that are used for defined purposes; specifically, client authentication is handled by WTLS (Wireless Transport Layer Security) protocol while digital signatures conform to the WMLScript (Wireless Markup Language Script) SignText protocol.

Therefore, an operating system for a device including a WIM can be readily adapted for the owner and user model required by this invention. The simplest approach is to assume a static set of owners and users for each kind of key. In cases where this is too inflexible, a dynamic control panel could be implemented to define how keys should be used. Examples of two ways of achieving this may be to:
Implement a separate key management UI for every single application that uses private keys, which would own all the keys in that application and assign any associated processes as other users of the keys. This implies no central key manager UI.
Implement a central key manager UI, which owns all keys and assigns applications as users as appropriate.

It should be noted that the differences between these two approaches are purely at user interface (UI) level.

Passphrase handling requires users of a device to manually authorize certain operations on the keystore by providing the correct passphrase or PIN. As described earlier, this scheme or an equivalent would have to be mandatory for all keystore accesses on platforms where secure identification of processes is not possible; however, even on secure platforms, at least some manual authentication is necessary, as a completely automatic process provides no security against the theft of the device itself.

It is known for such a passphrase to be cached for a period of time, so as not to annoy the user when several operations are carried out in quick succession. In this invention, it is preferable that the timeouts governing the validity of the cache be set on a per-process (i.e. per owner) basis as described in GB Patent Application no 0329835.3 entitled “A Method for Secure Operation of a Computing Device”.

Passphrase handling in accordance with the present invention uses an authentication object API. Briefly, a cryptotoken object provides an API to list the authentication objects in that token, and each authentication object provides methods to change the passphrase and set the passphrase cache timeout. For security reasons, passphrases are never seen by the client application. Instead, the change passphrase API triggers a dialog asking the user to enter and confirm the new password, and the entire process is not visible to the client. This has two advantages; the user of a key does not need to be trusted with the key passphrase because the passphrase never appears in the API, and anyone wishing to implement a key manager using some other authentication object, for example using biometrics, is able to do so within the existing API.

For the keystore, there is only one passphrase, and hence only one authentication object. The ‘change passphrase’ method causes the passphrase to be changed for the entire store. However, the ‘set timeout’ method only sets the timeout for keys owned by the calling process, and does not affect timeouts set by other key owners.

Passphrases are cached by the key manager (because caching is per-process), and an identification of the process which is the key owner is stored with each passphrase (because caching is also per-owner). When performing an operation for a valid user of a key, the key manager first determines the identity of the owning process and then checks to see if it has the passphrase for that owner cached. If not, the user is prompted to enter the passphrase.

Cached passphrases are expired using a timer. The timer is started when the passphrase is cached, and the cached passphrase is removed when the timer expires. It is also possible to specify that passphrases are never cached, or that cached passphrases never timeout.

The design of a secure keystore in accordance with this invention may be implemented as follows. In this example, the Symbian OS™ operating system is used as a sample implementation of the above keystore techniques. It is assumed that the person skilled in this art is familiar with the programming idioms of the Symbian OS™ operating system and will readily be able to adapt the techniques disclosed here to other operating system environments.

In this example of the invention each key is stored as a separate stream, and all keys are stored in a persistent stream store because this is an easy and efficient way of storing multiple streams. The commit/revert capabilities of the persistent store are used to ensure that the store is always consistent.

The encryption is implemented via the secure stream classes. These use the PKCS#5 key generation algorithm which is a standard for deriving keys from a passphrase. To protect against dictionary based attacks, this standard uses a large number of iterations of the basic algorithm (1000 is recommended) to make the process of deriving each key relatively slow. This time is considered acceptable when deriving one key, but unacceptable when an attempt is made to derive a full dictionary of keys. To protect against someone building a re-usable derived dictionary, for instance by organizing a distributed effort to generate the decrypt keys corresponding to every word in a dictionary, the key may be merged with a salt (a random string that is stored in the clear along with the encrypted object).

Encryption is carried out using the AES algorithm. All keys encrypted with the same passphrase will share a salt, so that the decryption key can be cached rather than the passphrase. Predominantly, this is done for efficiency reasons, although this is also arguably more secure and the increased efficiency allows higher iteration counts. The salt is changed whenever the passphrase is changed.

The root stream of the store contains an index of all the keys. This contains the store's global data, and a list of the IDs of streams containing information about each key. These streams in turn contain a pointer to another stream containing the encrypted PKCS#8 objects corresponding to each key. This is shown in FIG. 1.

The keystore API supplies interfaces for tokens that contain keystores. This is shown in FIG. 2.

The MCTKeyStore interface supports ‘user’ operations on the keystore: listing keys, exporting public keys and opening keys for sign/decrypt/agree operations.

CCTKeyInfo objects are used to describe keys, and contain all the attributes described in the functional specification.

Cryptographic operations on keys are performed by ‘opening’ the key for the required operation. This creates an object that can be used to perform the operation. Objects that implement the MRSASigner and MDSASigner interfaces are created for RSA and DSA signing. There is a single interface for decryption, MCTDecryptor, and one for Diffie-Hellman key agreement, MCTDH.

The MCTKeyStoreManager interface extends the MCTKeyStore interface to support ‘owner’ operations on keys: creating key, import and export, delete key, set key users, set passphrase timeout and relock store. In this example, however, the keystore API does not support encryption and verification operations—for these the client application must retrieve the appropriate public key and perform the operations itself.

The software keystore is implemented using a client/sever architecture. The client implements the appropriate cryptotoken interfaces, and forwards requests to the server. All cryptographic operations are performed within the server in order to reduce the exposure of private keys.

The software keystore is part of the filetokens component. This provides a common framework for software (i.e. file based) implementations of cryptotokens. This is also included in the certificate applications store.

The keystore client uses the cryptotoken framework, and may be instantiated directly, or through an ECOM plugin. The client implements a cryptotoken type containing a single token, which is the software keystore. With the exception of direct instantiation, all interaction with the client is via the cryptotoken and keystore APIs.

The software keystore has one token type (software keystores) and this supports one token, namely the software keystore itself. FIG. 3 shows the keystore implementation of the main cryptotoken framework API.

The CCTTokenType class is a base class for token types and is part of the cryptotokens module.

The CFSTokenTypeClient is a generic filetokens class that provides an implementation for token types. Its constructor takes the UID of the desired token type as a parameter. In this case, the UID would be that of the software keystore token type. It creates an RFileStoreClientSession object to communicate with the filetokens server. As defined by the MCTTokenType interface, it has a method to list available tokens—there is only ever one, the software keystore token—and a method to open available tokens.

The CFSTokenClient is another generic filetokens class, representing a token. A constructor parameter indicates which store it represents. It is created by the CFSTokenTypeClient's OpenToken method. It has a reference to the token type and to its session object, used to communicate with the server. It supports the MCTToken interface, which has a method to open an interface.

The keystore token supports two interfaces—the ‘user’ and ‘owner’ interfaces, represented by MCTKeyStore and MCTKeyStoreManager. These are implemented by the CFSKeyStoreClient class, which represents the keystore itself. This is created by the CFSTokenClient in response a GetInterface call with the appropriate interface. It has a reference to the session object. The same object is created regardless of whether the client asks for the ‘user’ or ‘owner’ interface—this means that the client could ask for the user interface and cast the pointer to get the owner interface. However, permissions are checked on the server for every operation, so this does not pose a security risk. The implementation of the rest of the keystore API is shown in FIG. 4.

Opening keys for use creates the appropriate object—one of MRSASigner, MDSASigner, MCTDecryptor or MCTDH. These all derive from COpenedKey, a base class that keeps a reference to the key store client object to perform the operations. They implement the appropriate interfaces defined in the API.

The structure of the keystore server is shown in FIG. 5.

When the server is started, an instance of CTokenServer is created. This is the main server class, and is responsible for creating server-side session objects when clients connect to the server. This is not specific to the keystore, but is part of the generic filetokens server.

The CTokenServer instance creates a single instance of the CFSKeyStoreServer class representing the keystore server itself. This in turn creates a CFileKeyDataManager object, which is responsible for writing to the store and maintaining a list of keys in memory.

When a keystore client connects to the server, an instance of CKeyStoreSession is created to represent the client session. This is used to hold session specific information, and implements the passphrase caching. This receives requests from the client, unmarshals the arguments, and forwards them to the CFSKeyStoreServer instance. It then marshals the return data and sends it back to the client.

The present invention is considered to provide several advantages over known key manager systems:
The functional separation of key ownership from key use enables a more secure operating environment.
It allows applications trusted with cryptographic keys to selectively extend their trust to user applications.
It prevents untrusted programs accessing cryptographic information without permission.
It prevents malicious processes on the device which have penetrated keystore security from misusing cryptographic information.
It renders the ‘Phishing’ type of threats from processes seeking to masquerade as other processes less likely to succeed.
It ensures the safe removal of unused keys.
It permits the implementation of more intuitive and less intrusive user interfaces for secure applications involving cryptography.

In essence, therefore, a key manager according to the present invention provides a mechanism for distinguishing between authorised use and unauthorised use of a key by identifying an owning application for each key, which is authorised by the key manager to freely use a particular key, and is also trusted to ask for explicit confirmation from the user when considered appropriate, such as when the key is used in a signing operation. To allow for sharing of keys between applications, the owning application may be enabled to designate a list of other applications which are also trusted to use the key.

Although the present invention has been described with reference to particular embodiments, it will be appreciated that modifications may be effected whilst remaining within the scope of the present invention as defined by the appended claims.

1. A computing device arranged to provide secure use of data for cryptographic operations by
a. keeping each item of the said data in a keystore;
b. assigning ownership of items in the keystore to respective processes;
c. enabling respective processes to assign another process as a user of respective items;
d. enabling respective processes to delete or modify respective items; and
e. denying access to items in the keystore to processes that neither own an item nor have been assigned as a user of an item.

2. A device according to claim 1 wherein access to items in the keystore is controlled by a single keystore process.

3. A device according to claim 1 wherein the keystore process comprises a server.

4. A device according to claim 3 wherein the keystore server is arranged to control access to cryptographic data kept in a further device.

5. A device according to claim 1 wherein the items kept in the keystore include either cryptographic keys or security certificates, or both.

6. A device according to claim 1 wherein access to items in the keystore is further restricted by a requirement for an authentication of identity from a user of the device.

7. A device according to claim 6 wherein user authentication is by means of at least one of
a. manual entry of a passphrase or a PIN; or
b. verification of biometric data.

8. A device according to claim 6 wherein user authentication is valid for a limited period of time.

9. A device according to claim 8 where the period for which user identification is valid is varied between different processes.

10. A device according to claim 1 comprising multiple keystores each of which may have access controlled either by separate keystore process or by a central keystore process.

11. A device according to claim 1 in which the deletion or removal of a process from the device is accompanied by the deletion or removal of all items owned by the said process.

12. A method of operating a computing device for providing secure use of data for cryptographic operations, the method comprising
a. keeping each item of the said data in a keystore;
b. assigning ownership of items in the keystore to respective processes;
c. enabling respective processes to assign another process as a user of respective items;
d. enabling respective processes to delete or modify respective items; and
e. denying access to items in the keystore to processes that neither own an item nor have been assigned as a user of an item.

13. A method according to claim 12 wherein access to items in the keystore is controlled by a single keystore process.

14. A method according to claim 12 wherein the keystore process comprises a server.

15. A method according to claim 14 wherein the keystore server is arranged to control access to cryptographic data kept in a further device.

16. A method according to claim 12 wherein the items kept in the keystore include either cryptographic keys or security certificates or both.

17. A method according to claim 12 wherein access to items in the keystore is further restricted by a requirement for an authentication of identity from a user of the device.

18. A method according to claim 17 wherein user authentication is by means of at least one of
a. manual entry of a passphrase or a PIN; or
b. verification of biometric data.

19. A method according to claim 17 wherein user authentication is arranged to be valid for a limited period of time.

20. A method according to claim 19 wherein the period for which user identification is valid is varied between different processes.

21. A method according to claim 12 comprising using multiple keystores each of which has access controlled either by a separate keystore process or by a central keystore process.

22. A method according to claim 12 in which the deletion or removal of a process from the device is accompanied by the deletion or removal of all items owned by the said process.

23. An operating system for a computing device according to claim 1.

24. An operating system for causing a computing device to operate according to the steps of claim 12.
